(19) United States
(12) Patent Application Publication
(10) Pub. No.: US 2026/0066539 A1
(43) Pub. Date: Mar. 5, 2026

(54) ANTENNA STRUCTURE AND ANTENNA DEVICE INCLUDING THE SAME

(71) Applicant: Samsung Electronics Co., Ltd., Suwon-si (KR)

(72) Inventors: Seongjung KIM, Suwon-si (KR); Woncheol LEE, Suwon-si (KR); Youngki LEE, Suwon-si (KR); Hyung Sun LIM, Suwon-si (KR)

(73) Assignee: Samsung Electronics Co., Ltd., Suwon-si (KR)

(21) Appl. No.: 19/080,623

(22) Filed: Mar. 14, 2025

(30) Foreign Application Priority Data
Aug. 27, 2024 (KR) 10-2024-0115003

(51) Int. Cl. H01Q 5/371; H01Q 5/385

(52) U.S. Cl. CPC H01Q 5/371; H01Q 5/385

(57) ABSTRACT

An antenna device includes a feed line extending in a first direction on one surface of a substrate, a first antenna element connected to the feed line in a second direction, substantially perpendicular to the first direction, a second antenna element connected to the feed line, spaced apart from the first antenna element at a predetermined interval, and extending in a third direction opposite to the second direction, and a communication circuit for transmitting a radio-frequency (RF) signal of a predetermined frequency band through the first and second antenna elements by feeding power to one end of the feed line. The feed line may include first and second connection portions connected to the first and second antenna elements, respectively, and a first intermediate portion between the first and second connection portions. The first intermediate portion may have a width smaller than that of the first or second connection portion.

### CROSS-REFERENCE TO RELATED APPLICATION(S)

This U.S. non-provisional application claims priority under 35 USC § 119 to Korean Patent Application No. 10-2024-0115003, filed on Aug. 27, 2024, in the Korean Intellectual Property Office, the disclosure of which is herein incorporated by reference in its entirety.

### BACKGROUND

Example embodiments relate to an antenna structure and an antenna device including the same.

Recently, there has been a growing trend of providing various communication and multimedia services for vehicles. For example, with the development of autonomous vehicles, communication technologies for enabling autonomous vehicles to continuously communicate with a roadside infrastructure or other vehicles and exchange or share traffic information therewith are being applied to vehicles.

Accordingly, a plurality of antennas are being installed in vehicles. For example, an antenna device operating in a frequency band ranging from approximately 76 GHz to 81 GHz may be mounted on a vehicle to detect objects over medium to long distances from the vehicle.

Such an antenna device requires low loss and high radiation efficiency to detect objects over longer distances and wider ranges. In addition, such an antenna device requires a wideband operation, so that it should have consistent radiation patterns over a wide bandwidth while maintaining low loss and high radiation efficiency.

### SUMMARY

Example embodiments provide an antenna device for supporting a wide bandwidth.

According to an example embodiment, an antenna device transmitting a radio-frequency (RF) signal includes a feed line extending in a first direction on one surface of a substrate, a first antenna element connected to the feed line in a second direction, substantially perpendicular to the first direction, a second antenna element connected to the feed line, spaced apart from the first antenna element at a predetermined interval, and extending in a third direction, substantially perpendicular to the first direction and opposite to the second direction, and a communication circuit configured to transmit the RF signal of a predetermined frequency band through the first antenna element and the second antenna element by feeding power to one end of the feed line. The feed line may include a first connection portion connected to the first antenna element, a second connection portion connected to the second antenna element, and a first intermediate portion between the first connection portion and the second connection portion, and each of the first connection portion and the second connection portion may have a first width, and the first intermediate portion may have a second width smaller than the first width.

According to an example embodiment, an antenna structure transmitting a radio-frequency (RF) signal includes a feed line, extending in a first direction on one surface of a printed circuit board, and a plurality of antenna elements alternately connected to the feed line at predetermined intervals in a second direction and a third direction, substantially perpendicular to the first direction. The feed line may include a plurality of connection portions, to which the plurality of antenna elements are respectively connected, and portions excluding the plurality of connection portions. Each of the plurality of connection portions may have a first width, and each of the portions excluding the plurality of connection portions may have a second width smaller than the first width.

According to an example embodiment, an antenna device includes a substrate, a feed line extending in a first direction on one surface of the substrate, a plurality of antenna elements connected to the feed line at predetermined intervals on one surface of the substrate, and a communication circuit configured to transmit a signal of a predetermined frequency band through the plurality of antenna elements by feeding power to one end of the feed line. The feed line may include a plurality of connection portions connected to the plurality of antenna elements, respectively, and portions excluding the plurality of connection portions, and each of the plurality of connection portions may have a first width, and each of the portions excluding the plurality of connection portions may have a second width different from the first width.

### BRIEF DESCRIPTION OF DRAWINGS

FIG. 1 is a diagram illustrating an antenna device according to an example embodiment.

FIG. 2 is a plan view illustrating a feed line and antenna elements disposed on a substrate according to an example embodiment.

FIG. 3 is a diagram illustrating a frequency-dependent radiation pattern, of an RF signal transmitted by an antenna device according to an example embodiment, with respect to a direction perpendicular to one surface of the substrate.

FIG. 4 is a plan view illustrating an antenna device including a feed line and antenna elements having predetermined shapes, according to an example embodiment.

FIG. 5A is a diagram illustrating a shape of a first antenna element connected to a first connection portion according to an example embodiment.

FIG. 5B is a diagram illustrating a shape of a first antenna element connected to a first connection portion according to an example embodiment.

FIG. 6 is a diagram illustrating an antenna device according to an example embodiment.

FIG. 7 is a plan view illustrating an antenna device including a feed line, antenna elements, and parasitic elements, according to an example embodiment.

FIG. 8 is a diagram illustrating a shape of a first parasitic element according to an example embodiment.

FIG. 9 is a diagram illustrating an antenna device further including a termination extension, according to an example embodiment.

FIG. 10 is a block diagram illustrating a wireless communication device according to an example embodiment.

FIG. 11 is a block diagram illustrating an IoT device including an electronic device according to an example embodiment.

FIG. 12 is a block diagram illustrating a mobile terminal to which an electronic device according to an example embodiment is applied.

### DETAILED DESCRIPTION

Hereinafter, example embodiments will be described with reference to the accompanying drawings.

The term “first,” “second,” or the like used herein may modify various elements regardless of the order and/or priority thereof, and is used only for distinguishing one element from another element, without limiting example embodiments.

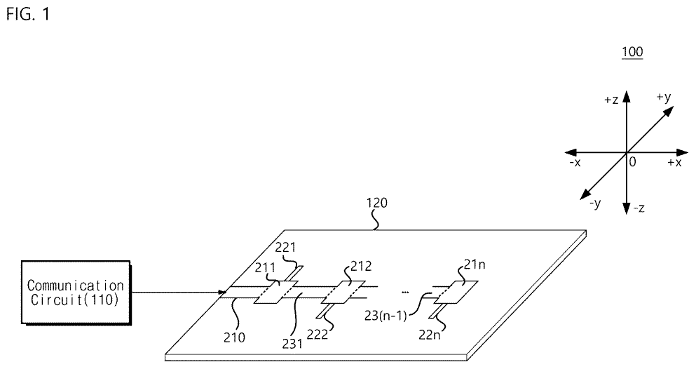

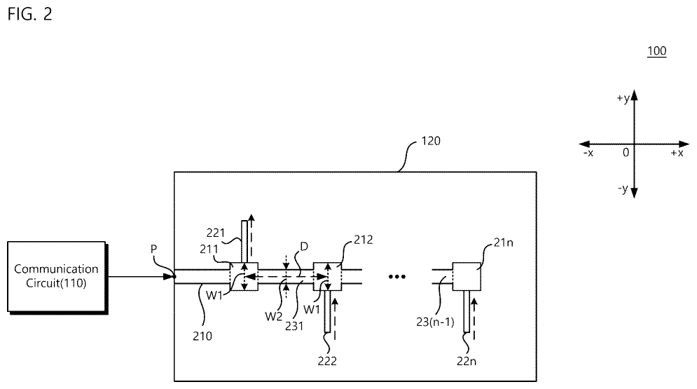

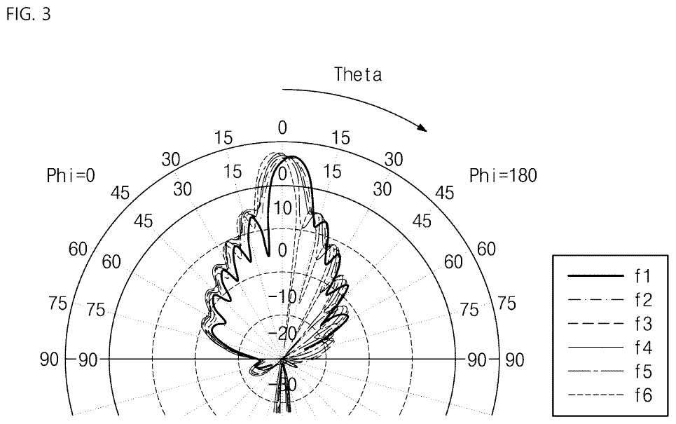

FIG. 1 is a diagram illustrating an antenna device according to an example embodiment. FIG. 2 is a plan view illustrating a feed line and antenna elements disposed on a substrate according to an example embodiment. FIG. 3 is a diagram illustrating a frequency-dependent radiation pattern, of an RF signal transmitted by an antenna device according to an example embodiment, with respect to a direction perpendicular to one surface of the substrate.

Referring to FIG. 1, an antenna device 100 according to an example embodiment may include a communication circuit 110, a substrate 120, a feed line 210, and a plurality of antenna elements 221 to 22n (where n is an arbitrary positive integer).

For example, the antenna device 100 may be installed in a means of transportation, including a vehicle. In addition, the antenna device 100 may perform a function of detecting a surrounding area at a predetermined interval or width from the means for transportation. For example, the antenna device 100 may be referred to as a radar device.

However, a device provided with the antenna device 100 and functions of the antenna device 100 are not limited to the above-described examples. For example, the antenna device 100 may be installed in a mobile terminal or an Internet of Things (IoT) device.

According to an example embodiment, the antenna device 100 may include a substrate 120.

For example, the substrate 120 may include at least one metal interconnection, electrically connecting at least two components mounted on the substrate 120. Therefore, the substrate 120 may also be referred to as a printed circuit board (PCB).

Referring to FIGS. 1 and 2, the antenna device 100 may include a feed line 210 formed on one surface of the substrate 120.

For example, the antenna device 100 may include a feed line 210 extending in a first direction (for example, a positive x-direction) on one surface of the substrate 120.

In addition, the antenna device 100 may include a plurality of antenna elements 221 to 22n connected to the feed line 210 on one surface of the substrate 120.

For example, the antenna device 100 may include a plurality of antenna elements 221 to 22n connected to the feed line 210 in a second direction (for example, a positive y-direction) or a third direction (for example, a negative y-direction), substantially perpendicular to the first direction.

For example, the antenna device 100 may include a first antenna element 221 connected to the feed line 210 in a second direction (for example, a positive y-direction), substantially perpendicular to the first direction.

Also, for example, the antenna device 100 may include a second antenna element 222 connected to the feed line 210 in a third direction (for example, a negative y-direction), substantially perpendicular to the first direction and opposite to the second direction.

One of ordinary skill in the art would understand that the expression “substantially perpendicular” or “substantially parallel” may mean not only being exactly perpendicular (90°) or exactly parallel (0°), but also being close to perpendicular or parallel including process errors, positional deviations, and/or measurement errors that may occur in a manufacturing process, and the range thereof may be widely accepted in the art. In one or more aspects, the terms “substantially,” “about,” and “approximately” may provide an industry-accepted tolerance for their corresponding terms and/or relativity between items, such as a tolerance of ±1%, ±5%, or ±10% of the actual value stated, and other suitable tolerances.

Also, the plurality of antenna elements 221 to 22n may be connected to the feed line 210 to be spaced apart from each other by a predetermined interval D in the first direction.

For example, the first and second antenna elements 221 and 222 may be spaced apart from each other by the predetermined interval D in the first direction and connected to the feed line 210.

The predetermined interval D according to an example embodiment may have a value substantially same as half of a wavelength of a radio-frequency (RF) signal transmitted through the antenna device 100. As used herein, the expression “substantially same” may refer to being the same length value relative to the wavelength compared therewith, as will be appreciated by those of skill in the art, and allows for approximations, inaccuracies and limits of measurement under the relevant circumstances.

For example, the plurality of antenna elements 221 to 22n may be spaced apart from each other by a predetermined interval D in the first direction and alternately connected to the feed line 210 in the second direction (for example, the positive y-direction) and the third direction (for example, the negative y-direction).

For example, the antenna device 100 may further include a third antenna element spaced apart from the second antenna element 222 by a predetermined interval D in the first direction and connected to the feed line 210 in the second direction (for example, the positive y-direction).

According to an example embodiment, the feed line 210 and the plurality of antenna elements 221 to 22n may be integrally formed on one surface of the substrate 120. For example, the feed line 210 and the plurality of antenna elements 221 to 22n, integrally formed on one surface of the substrate 120, may be referred to as an antenna structure formed on the substrate 120.

According to an example embodiment, the antenna device 100 may include a communication circuit 110 controlling the antenna device 100 to transmit an RF signal in a predetermined frequency band.

For example, the communication circuit 110 may feed power to one end of the feed line 210 formed on the substrate 120. For example, the communication circuit 110 may feed power along the feed line 210 through a feed point P formed at one end of the feed line 210.

For example, the communication circuit 110 may feed power to the plurality of antenna elements 221 to 22n through the feed line 210.

As power is applied through the feed line 210, a current may be induced (or formed) in each of the plurality of antenna elements 221 to 22n.

For example, as the communication circuit 110 feeds power to the feed line 210, a current may flow in the second direction (for example, the positive y-direction) in each of the plurality of antenna elements 221 to 22n.

Accordingly, the plurality of antenna elements 221 to 22n may radiate a signal in a predetermined frequency band.

For example, the plurality of antenna elements 221 to 22n may radiate a signal in a predetermined frequency band in a direction, perpendicular to one surface of the substrate 120 (for example, the positive z-direction).

For example, the predetermined frequency band may include a frequency band of approximately 76 GHz to approximately 81 GHz.

For example, the communication circuit 110 may control the antenna device 100 to transmit a signal in a predetermined frequency band by feeding power to the antenna structure formed on one surface of the substrate 120.

In addition, according to an example embodiment, the feed line 210 may include a plurality of connection portions 211 to 21n, respectively connected to the plurality of antenna elements 221 to 22n.

For example, the feed line 210 may include a first connection portion 211 connected to the first antenna element 221. Also, for example, the feed line 210 may include a second connection portion 212 connected to the second antenna element 222.

In addition, the feed line 210 may include a plurality of intermediate portions 231 to 23(n−1) between the plurality of connection portions 211 to 21n.

For example, the feed line 210 may include a first intermediate portion 231 between the first connection portion 211 and the second connection portion 212. The first intermediate portion 231 may be understood as a portion connecting the first connection portion 211 and the second connection portion 212.

According to an example embodiment, each of the plurality of connection portions 211 to 21n may have a first width W1. Each of the plurality of intermediate portions 231 to 23(n−1) may have a second width W2, smaller than the first width W1. Each of the first width W1 and the second width W2 may refer to a length measured in the second or third direction.

For example, each of the first connection portion 211 and the second connection portion 212 may have the first width W1. Also, the first intermediate portion 231 between the first connection portion 211 and the second connection portion 212 may have the second width W2 smaller than the first width W1.

The portion of the feed line 210 having the second width W2 may be understood to have a relatively high input impedance when viewed from the feed point P, compared to the portion having the relatively large first width W1.

Referring to the above-described configurations, the plurality of intermediate portions 231 to 23(n−1) of the feed line 210 according to an example embodiment may have a relatively small second width W2, compared to the plurality of connection portions 211 to 21n.

For example, the feed line 210 according to an example embodiment may have a relatively high input impedance when viewed from the communication circuit 110, compared to a case in which the entire feed line 210 has the first width W1. Also, as the feed line 210 has a relatively high input impedance, the strength of a signal reflected from the other end of the feed line 210 may be reduced.

Accordingly, the antenna device 100 may reduce a phenomenon in which the radiation pattern of the RF signal varies depending on a frequency due to a destructive interference between the signal fed from the feed point P and the signal reflected from the other end of the feed line 210.

Referring to FIG. 3, the antenna device 100 according to an example embodiment may transmit an RF signal having a radiation pattern of a shape, substantially consistent in a direction perpendicular to the substrate 120 (for example, a positive z-direction) at each of the frequencies f1 to f6.

For example, f1 may be referred to as 76 GHz, f2 may be referred to as 77 GHz, f3 may be referred to as 78 GHz, f4 may be referred to as 79 GHz, f5 may be referred to as 80 GHz, and f6 may be referred to as 81 GHz.

Accordingly, the antenna device 100 may transmit an RF signal to have a radiation pattern of a shape, substantially consistent in a frequency band ranging from 76 GHz to 81 GHz.

The above-described configuration may enable the antenna device 100 according to an example embodiment to transmit an RF signal having a consistent radiation pattern across a wide bandwidth. For example, the antenna device 100 according to an example embodiment may significantly reduce a phenomenon in which an antenna gain decreases depending on a frequency.

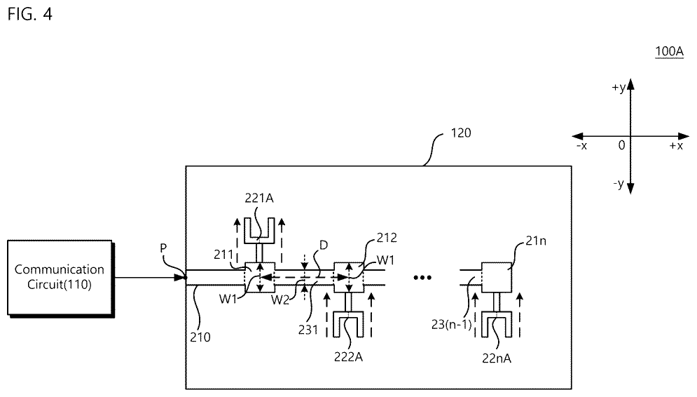

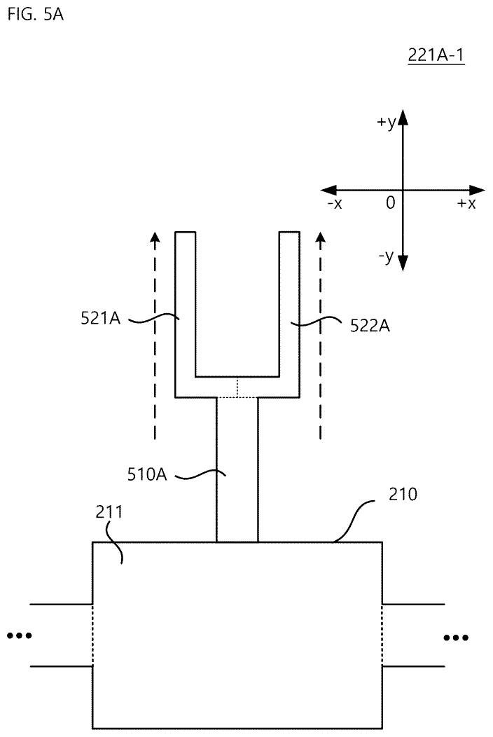

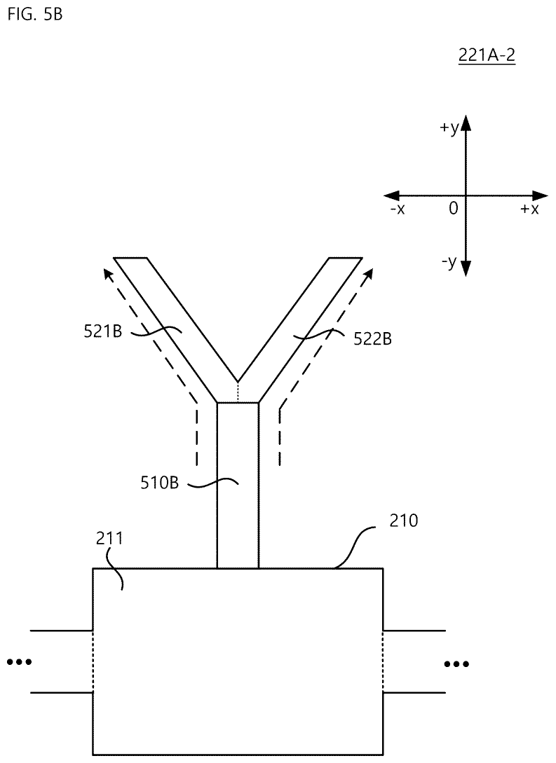

FIG. 4 is a plan view illustrating an antenna device including a feed line and antenna elements having predetermined shapes, according to an example embodiment. FIG. 5A is a diagram illustrating a shape of a first antenna element connected to a first connection portion according to an example embodiment. FIG. 5B is a diagram illustrating a shape of a first antenna element connected to a first connection portion according to an example embodiment.

Referring to FIG. 4, an antenna device 100A according to an example embodiment may include a feed line 210 and a plurality of antenna elements 221A to 22 nA disposed on one surface of a substrate 120.

The antenna device 100A of FIG. 4 may be understood as a modified example of the antenna device 100 illustrated in FIG. 2. Therefore, the same or substantially the same components are represented by the same reference numerals, and redundant descriptions will be omitted to avoid repetition.

According to an example embodiment, the antenna device 100A may include a plurality of antenna elements 221A to 22 nA connected to the feed line 210 on one surface of the substrate 120.

For example, the antenna device 100A may include a first antenna element 221A connected to the feed line 210 in a second direction (for example, a positive y-direction), substantially perpendicular to a first direction.

Also, for example, the antenna device 100A may include a second antenna element 222A connected to the feed line 210 in a third direction (for example, a negative y-direction), substantially perpendicular to the first direction and opposite to the second direction.

In addition, the plurality of antenna elements 221A to 22 nA may be connected to the feed line 210 to be spaced apart from each other by a predetermined interval D in the first direction. For example, the first antenna element 221A and the second antenna element 222A may be spaced apart by a predetermined interval D in the first direction and connected to the feed line 210.

For example, the plurality of antenna elements 221A to 22 nA may be spaced apart by a predetermined interval D in the first direction and alternately connected to the feed line 210 in the second direction (for example, the positive y-direction) and the third direction (for example, the negative y-direction).

Referring to FIGS. 4 to 5B, each of the plurality of antenna elements 221A to 22 nA according to an example embodiment may include a plurality of branches formed by branching from a single point.

Referring to FIG. 5A, a first antenna element 221A-1 according to an example embodiment may include a first extension 510A connected (or extending) from a first connection portion 211 in a second direction (for example, a positive y-direction).

The first antenna element 221A-1 illustrated in FIG. 5A may be referred to as an example of the first antenna element 221A illustrated in FIG. 4.

Also, the first antenna element 221A-1 may include at least two or more first branches 521A and 522A formed by branching from one end of the first extension 510A.

For example, the first antenna element 221A-1 may include a (1-1)-th branch 521A and a (1-2)-th branch 522A formed by branching from one end of the extension 510A.

According to an example embodiment, each of the (1-1)-th branch 521A and the (1-2)-th branch 522A may include at least a portion extending (or connected) in the second direction (for example, the positive y-direction).

For example, the first antenna element 221A-1 may include a (1-1)-th branch 521A branching from one end of the first extension 510A in a fourth direction (for example, a negative x-direction), opposite to the first direction, and extending in the second direction (for example, the positive y-direction).

Also, for example, the first antenna element 221A-1 may include a (1-2)-th branch 522A branching from one end of the first extension 510A in the first direction (for example, the positive x-direction) and extending in the second direction (for example, the positive y-direction).

For example, each of the (1-1)-th branch 521A and the (1-2)-th branch 522A may include at least a portion, extending in the second direction (for example, the positive y-direction) and parallel to each other.

Referring to FIG. 5B, a first antenna element 221A-2 according to an example embodiment may include a first extension 510B connected (or extending) from a first connection portion 211 in a second direction (for example, a positive y-direction).

The first antenna element 221A-2 illustrated in FIG. 5b may be referred to as an example of the first antenna element 221A illustrated in FIG. 4.

Also, the first antenna element 221A-2 may include at least two or more first branches 521B and 522B formed by branching from one end of the first extension 510B.

For example, the first antenna element 221A-2 according to an example embodiment may include a (1-1)-th branch 521B and a (1-2)-th branch 522B formed by branching from one end of the extension 510B.

For example, the first antenna element 221A-2 may include a (1-1)-th branch 521B extending from one end of the first extension 510B in a direction between a fourth direction (for example, a negative x-direction) and the second direction (for example, positive y-direction).

Also, for example, the first antenna element 221A-2 may include a (1-2)-th branch 522B extending from one end of the first extension 510B in a direction between the first direction (for example, the positive x-direction) and the second direction (for example, the positive y-direction).

For example, referring to FIGS. 5A and 5B, the first antenna element 221A according to an example embodiment may be formed to have a Y-shape, extending from the first connection portion 211 and branching at a single point.

Referring to FIGS. 4 to 5B, when the communication circuit 110 feeds power to the feed line 210, a current may flow in each of at least two branches of the first antenna element 221A.

Referring to FIG. 4, the second antenna element 222A to an n-th antenna element 22 nA may have substantially the same shape as the first antenna element 221A.

Referring to the above-described configurations, each of the plurality of antenna elements 221A to 22 nA according to an example embodiment may include an extension, extending in a direction perpendicular to the feed line 210, and a plurality of branches formed by branching from the extension.

Also, when the communication circuit 110 feeds power to the feed line 210, a current may flow to at least two branches included in each of the plurality of antenna elements 221A to 22 nA.

Accordingly, the current generated in the plurality of antenna elements 221A to 22 nA may have a relatively high density with respect to the first direction (for example, the positive x-direction), compared to a case in which each of the plurality of antenna elements 221A to 22 nA does not include branches.

As a result, the antenna device 100A according to an example embodiment may have an improved antenna gain.

Also, the plurality of intermediate portions 231 to 23(n−1) of the feed line 210 according to an example embodiment may have a relatively small second width W2, compared to the plurality of connection portions 211 to 21n.

Accordingly, the antenna device 100A may reduce a phenomenon in which a radiation pattern of an RF signal varies depending on a frequency due to a destructive interference between a signal fed from the feed point P and a signal reflected from the other end of the feed line 210.

As a result, the antenna device 100A according to an example embodiment may transmit an RF signal having a consistent radiation pattern across a wide bandwidth. For example, the antenna device 100A according to an example embodiment may significantly reduce a phenomenon in which an antenna gain decreases depending on a frequency.

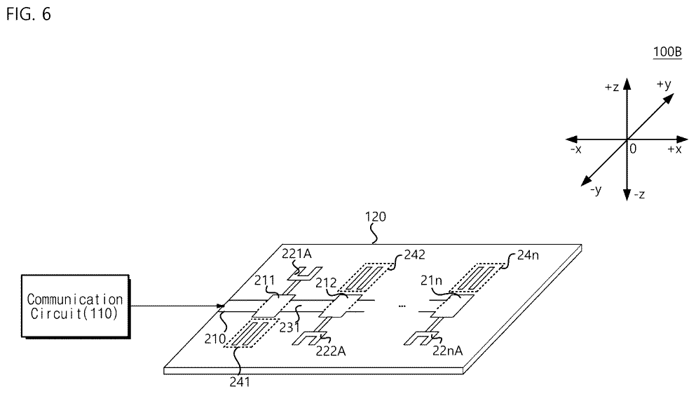

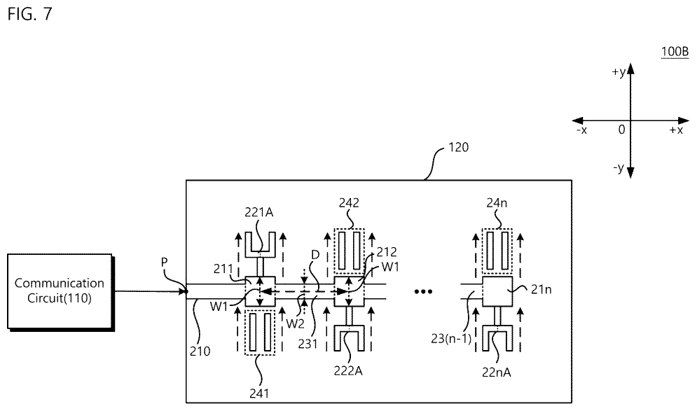

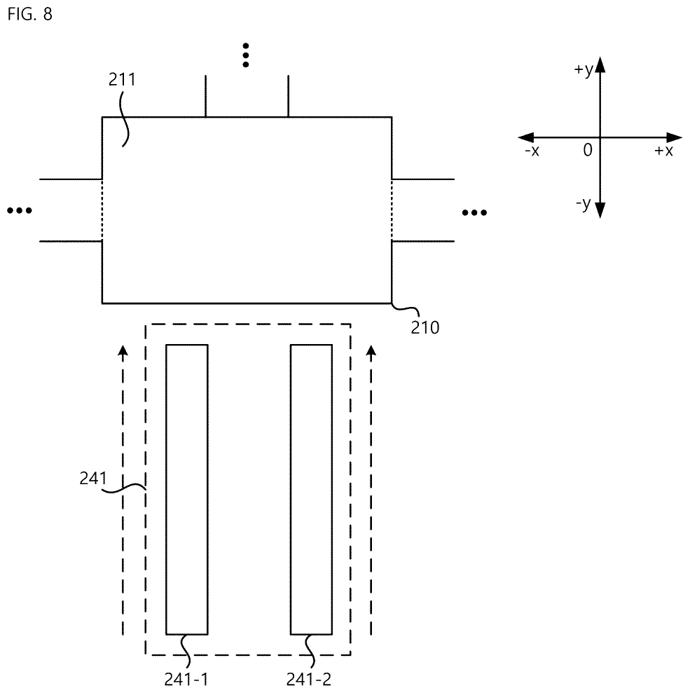

FIG. 6 is a diagram illustrating an antenna device according to an example embodiment. FIG. 7 is a plan view illustrating an antenna device including a feed line, antenna elements, and parasitic elements, according to an example embodiment. FIG. 8 is a diagram illustrating a shape of a first parasitic element according to an example embodiment.

Referring to FIGS. 6 and 7, the antenna device 100B according to an example embodiment may include a communication circuit 110, a substrate 120, a feed line 210, a plurality of antenna elements 221A to 22 nA, and a plurality of parasitic elements 241 to 24n.

The antenna device 100B illustrated in FIGS. 6 and 7 may be understood as a modified example of the antenna device 100 illustrated in FIG. 2. Also, the antenna device 100B illustrated in FIGS. 6 and 7 may be understood as further including the plurality of parasitic elements 241 to 24n, compared to the antenna device 100A illustrated in FIG. 4.

Therefore, the same or substantially the same components are represented by the same reference numerals, and redundant descriptions will be omitted to avoid repetition.

According to an example embodiment, the antenna device 100B may include a plurality of antenna elements 221A to 22 nA, alternately connected to the feed line 210 in a second direction (for example, a positive y-direction) and a third direction (for example, a negative y-direction).

The plurality of antenna elements 221A to 22 nA may be disposed to be spaced apart from each other by a predetermined interval D in the first direction (for example, the positive x-direction).

Also, the antenna device 100B according to an example embodiment may include a plurality of parasitic elements 241 to 24n disposed to be spaced apart from the feed line 210 in the second direction (for example, the positive y-direction) or the third direction (for example, the negative y-direction).

For example, the antenna device 100B may include a plurality of parasitic elements 241 to 24n disposed to be spaced apart from the feed line 210 at a location opposing a respective one of the plurality of antenna elements 221A to 22 nA and the feed line 210.

For example, the antenna device 100B may include a first parasitic element 241 disposed to be spaced apart from the feed line 210 at a location opposing the first antenna element 221A and a first connection portion 211.

Also, for example, the antenna device 100B may include a second parasitic element 242 disposed to be spaced apart from the feed line 210 at a location opposing the second antenna element 222A and a second connection portion 212.

Referring to FIG. 8, the first parasitic element 241 according to an example embodiment may include at least two first parasitic radiators 241-1 and 241-2, each extending in a second direction (for example, a positive y-direction).

For example, the first parasitic element 241 may include a (1-1)-th parasitic radiator 241-1 and a (1-2)-th parasitic radiator 241-2, each extending in the second direction (for example, the positive y-direction).

The (1-1)-th parasitic radiator 241-1 and the (1-2)-th parasitic radiator 241-2 according to an example embodiment may be disposed, substantially parallel to each other, in a first direction (for example, a positive x-direction).

Referring to FIGS. 7 and 8, the first parasitic element 241 may be electromagnetically coupled to the feed line 210 when the communication circuit 110 feeds power to the feed line 210.

For example, the (1-1)-th parasitic radiator 241-1 and the (1-2)-th parasitic radiator 241-2 may each be electromagnetically coupled with the feed line 210 when the communication circuit 110 feeds power to the feed line 210.

For example, when the communication circuit 110 feeds power to the feed line 210, a current may be induced in each of the (1-1)-th parasitic radiator 241-1 and the (1-2)-th parasitic radiator 241-2 in the second direction (for example, the positive y-direction).

The current induced in each of the (1-1)-th parasitic radiator 241-1 and the (1-2)-th parasitic radiator 241-2 may be understood to be generated by electromagnetic induction.

Also, each of the second parasitic element 242 to the n-th parasitic element 24n may have substantially the same shape as the first parasitic element 241.

For example, when the communication circuit 110 feeds power to the feed line 210, a current may be induced in each of the second parasitic element 242 to the n-th parasitic element 24n in the second direction (for example, the positive y-direction).

Referring to the above-described configuration, the antenna device 100B according to an example embodiment may include a plurality of antenna elements 221A to 22 nA spaced apart from each other by a predetermined interval D and alternately connected to the feed line 210.

Also, the antenna device 100B may further include a plurality of parasitic elements 241 to 24n disposed to be spaced apart from the feed line 210 at a location opposing each of the plurality of antenna elements 221A to 22 nA and the feed line 210.

When the communication circuit 110 feeds power to the feed line 210, an induced current may be generated in each of the plurality of parasitic elements 241 to 24n through coupling.

Accordingly, the current induced by the power feeding of the communication circuit 110 in the antenna device 100B may have a relatively high density with respect to the first direction (for example, the positive x-direction), compared to a case in the plurality of parasitic elements 241 to 24n are not included.

As a result, the antenna device 100B according to an example embodiment may have an improved antenna gain.

Also, the plurality of intermediate portions 231 to 23(n−1) of the feed line 210 according to an example embodiment may have a relatively small second width W2 compared to the plurality of connection portions 211 to 21n.

Referring to FIGS. 7 and 8, when the communication circuit 110 feeds power to the feed line 210, a current may be induced in the plurality of antenna elements 221A to 22 nA in a second direction (for example, a positive y-direction).

For example, when the communication circuit 110 feeds power to the feed line 210, a current may be induced in each of the plurality of antenna elements 221A to 22 nA and the plurality of parasitic elements 241 to 24n in the second direction (for example, the positive y-direction).

Accordingly, the antenna device 100B may reduce a phenomenon in which a direction of a current induced in an antenna radiator varies depending on a frequency due to destructive interference between a signal fed from a feed point P and a signal reflected from the other end of the feed line 210.

As a result, the antenna device 100B according to an example embodiment may transmit an RF signal having a consistent radiation pattern across a wide bandwidth.

For example, the antenna device 100B according to an example embodiment may significantly reduce a phenomenon in which the antenna gain decreases depending on a frequency.

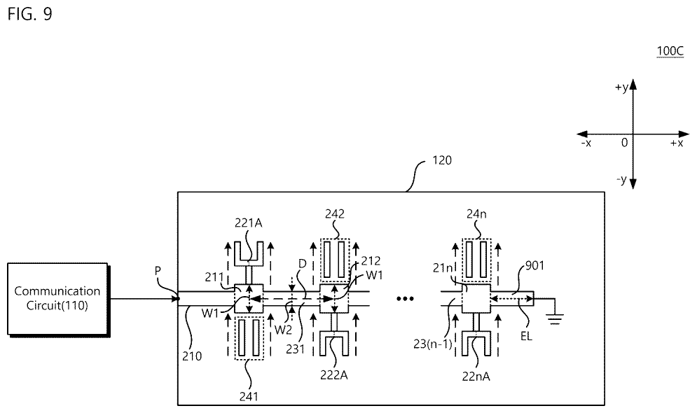

FIG. 9 is a diagram illustrating an antenna device further including a termination extension, according to an example embodiment.

Referring to FIG. 9, an antenna device 100C according to an example embodiment may include a communication circuit 110, a substrate 120, a feed line 210, a plurality of antenna elements 221A to 22 nA, and a plurality of parasitic elements 241 to 24n. The antenna device 100C may further include a termination extension 901 extending from the other end of the feed line 210.

The antenna device 100C illustrated in FIG. 9 may be understood as a modified example of the antenna device 100 illustrated in FIG. 2. Also, the antenna device 100C illustrated in FIG. 9 may be understood to further include a termination extension 901, compared to the antenna device 100B illustrated in FIG. 7.

Therefore, the same or substantially the same components are represented by the same reference numerals, and redundant descriptions will be omitted to avoid repetition.

According to an example embodiment, the antenna device 100C may include a termination extension 901 extending from the other end of the feed line 210 in the first direction (for example, the positive x-direction), but not limited thereto. The other end of the feed line 210 may be understood as a termination different from one end, at which the feed point P is formed, of the feed line 210.

For example, the antenna device 100C may include a termination extension 901 extending from the other end of the feed line 210 in the first direction (for example, the positive x-direction) by an extension length EL.

The extension length EL may be understood as having a value obtained by adding a quarter of a wavelength of an RF signal transmitted through the antenna device 100C and a non-negative integer multiple of half the wavelength of the RF signal.

According to an example embodiment, the termination extension 901 may be connected to ground.

Referring to the above-described configuration, the antenna device 100C may cause total reflection at the other end of the feed line 210 through the termination extension 901 connected to the ground.

Also, the antenna device 100C according to an example embodiment may relatively reduce energy loss caused by resistance, compared to a case in which the other end of the feed line 210 is connected to a resistor.

As a result, the antenna device 100C according to an example embodiment may reduce energy loss consumed in a process of transmitting an RF signal.

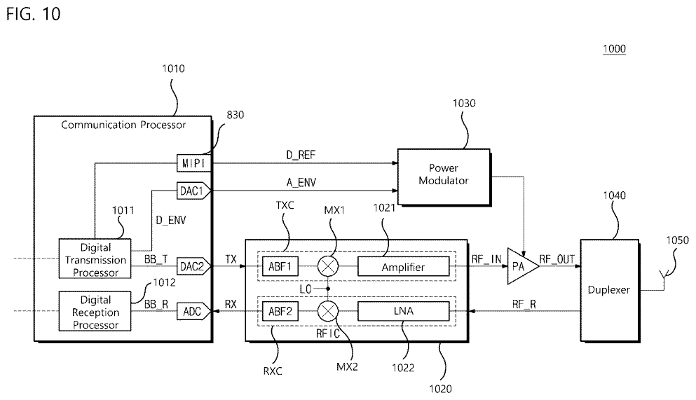

FIG. 10 is a block diagram illustrating a wireless communication device according to an example embodiment.

Referring to FIG. 10, a wireless communication device 1000 according to an example embodiment may include a communication processor 1010, an RFIC 1020, a power modulator 1030, a duplexer 1040, a power amplifier PA, and an antenna 1050.

The wireless communication device 1000 and the configuration thereof illustrated in FIG. 10 may be understood as including the antenna device 100 and the configuration thereof illustrated in FIG. 1. For example, the communication processor 1010 illustrated in FIG. 10 may be understood as having substantially the same configuration as the communication circuit 110 illustrated in FIG. 1. Therefore, redundant descriptions will be omitted to avoid repetition.

The communication processor 1010 may process a baseband signal BB_T according to a predetermined communication scheme through an internal digital transmission processor 1011. Also, the communication processor 1010 may process a received baseband signal BB_R according to a predetermined communication scheme through a digital reception processing unit 1012.

For example, the communication processor 1010 may process a signal to be transmitted or a received signal using a communication scheme such as orthogonal frequency division multiplexing (OFDM), orthogonal frequency division multiplexing access (OFDMA), wideband code a plurality of access (WCDMA), or high speed packet access+(HSPA+). In addition, the communication processor 1010 may process the baseband signal BB_T or BB_R using various types of communication schemes (for example, various communication schemes to which a technique of modulating or demodulating the amplitude and frequency of the baseband signal BB_T or BB_R is applied).

The communication processor 1010 may extract an envelope of the baseband signal BB_T through the digital transmission processor 1011 and generate a digital envelope signal D_ENV based on the extracted envelope. Also, the communication processor 1010 may generate an average power signal D_REF based on the average power tracking table stored in a memory. The extracted envelope may correspond to an amplitude component of the baseband signal BB_T (for example, magnitudes of an I signal and a Q signal).

The communication processor 1010 may perform digital-to-analog conversion on each of the baseband signal BB_T and the digital envelope signal D_ENV using a plurality of digital-to-analog converters DAC1 and DAC2 provided therein to generate a transmit signal TX and an analog envelope signal A_ENV, analog signals. For example, the average power signal D_REF output from the communication processor 1010 may be a digital signal.

Accordingly, the average power signal D_REF may be provided to a digital-to-analog converter, provided in the power modulator 1030, through MIPI 830 and may be converted into an analog signal, for example, a reference voltage signal, through the digital-to-analog converter provided in the power modulator 1030. For reference, the digital-to-analog converters DAC1 and DAC2 provided in the communication processor 1010 may operate at a higher speed than the digital-to-analog converter provided in the power modulator 1030.

However, example embodiments are not limited thereto, and the communication processor 1010 may convert the average power signal D_REF into an analog signal through the digital-to-analog converter provided therein and output the converted analog signal. The communication processor 1010 may provide the average power signal, converted into an analog signal, to the power modulator 1030 as a reference voltage signal.

For ease of description, an example will be provided in which the communication processor 1010 provides the average power signal D_REF to the digital-to-analog converter, provided in the power modulator 1030, through a mobile industry processor interface (MIPI) 830.

For reference, each of the transmission signal TX and the analog envelope signal A_ENV may be a differential signal including a positive signal and a negative signal.

Also, the communication processor 1010 may receive a receive signal RX, an analog signal, from the RFIC 1020. Also, the communication processor 1010 may extract a baseband signal BB_R, a digital signal, by performing analog-to-digital conversion on the receive signal RX through an analog-to-digital converter ADC provided therein.

The RFIC 1020 may generate an RF input signal RF_IN by performing up-conversion on the transmit signal TX or may generate a receive signal RX by performing down-conversion on an RF receive signal RF_R. For example, the RFIC 1020 may include a transmission circuit TXC for up-conversion, a receiving circuit RXC for down-conversion, and a local oscillator LO.

The transmission circuit TXC may include a first analog baseband filter ABF1, a first mixer MX1, and an amplifier 1021. For example, the first analog baseband filter ABF1 may include a low pass filter.

The first analog baseband filter ABF1 may filter the transmit signal TX received from the communication processor 1010 and provide the filtered transmit signal TX to the first mixer MX1. Also, the first mixer MX1 may perform up-conversion to convert a frequency of the transmit signal TX from a baseband to a high-frequency band using a frequency signal provided by the local oscillator LO. Such up-conversion may enable the transmit signal TX to be provided to the amplifier 1021 as an RF input signal RF_IN, and enable the amplifier 1021 to amplify the power of the RF input signal RF_IN firstly and provide the amplified RF input signal RF_IN to the power amplifier PA.

The power amplifier PA may receive a power supply voltage (for example, a dynamically variable output voltage) from the power modulator 1030 and generate an RF output signal RF_OUT by amplifying power of the RF input signal RF_IN secondly based on the supplied power supply voltage. Also, the power amplifier PA may provide the generated RF output signal RF_OUT to the duplexer 1040.

The receiving circuit RXC may include a second analog baseband filter ABF2, a second mixer MX2, and a low-noise amplifier 1022. For example, the second analog baseband filter ABF2 may include a low pass filter.

The low-noise amplifier 1022 may amplify the RF receive signal RF_R provided from the duplexer 1040, and provide the amplified RF receive signal RF_R to the second mixer MX2. And, the second mixer MX2 may perform down-conversion to convert the frequency of the received signal RF_R from a high-frequency band to a baseband using a frequency signal provided by the local oscillator LO. Such down-conversion may enable the RF receive signal RF_R to be provided as the receive signal RX to the second analog baseband filter ABF2, and the second analog baseband filter ABF2 may filter the receive signal RX and provide the filtered receive signal RX to the communication processor 1010.

For reference, the wireless communication device 1600 may transmit a transmit signal through a plurality of frequency bands using carrier aggregation (CA). To this end, the wireless communication device 1600 may include a plurality of power amplifiers amplifying a plurality of RF input signals RF_IN, respectively corresponding to the plurality of carriers. For ease of description, an example is provided in which there is only one power amplifier PA.

The power modulator 1030 may generate a modulated output voltage having a level varying dynamically based on the analog envelope signal A_ENV and the average power signal D_REF, and may provide the modulated output voltage as a power supply voltage to the power amplifier PA.

For example, the power modulator 1030 may receive the average power signal D_REF and the analog envelope signal A_ENV from the communication processor 910. Also, the power modulator 1030 may generate an output voltage, which is dynamically variable, driven by either ET mode or APT mode based on the provided average power signal D_REF and the analog envelope signal A_ENV. Also, the power modulator 1030 may supply the generated output voltage as a power supply voltage to the power amplifier PA.

For reference, when a fixed level of power supply voltage is applied to the power amplifier PA, the power efficiency of the power amplifier PA may be reduced. Accordingly, the power modulator 1030 may efficiently manage the power of the power amplifier PA by modulating an input voltage (for example, power supplied from a battery) based on at least one of the analog envelope signal A_ENV and the average power signal D_REF and providing the modulated voltage as a power supply voltage to the power amplifier PA.

The duplexer 1040 may be connected to the antenna 1050 to separate a transmission frequency and a receiving frequency. For example, the duplexer 1040 may separate the RF output signal RF_OUT, provided from the power amplifier PA, for each frequency band and provide the separated RF output signal RF_OUT to a corresponding antenna 1050.

Also, the duplexer 1040 may provide an external signal, received from the antenna 1050, to the low-noise amplifier 1022 of the receiving circuit RXC of the RFIC 1020. For example, the duplexer 1040 may include a front end module with integrated duplexer (FEMiD).

For reference, the wireless communication device 1000 may be provided with a switch structure to separate a transmission frequency and a reception frequency, instead of the duplexer 1040. Also, the wireless communication device 1000 may be provided with a structure including a duplexer 1040 and a switch to separate the transmission frequency and the receiving frequency. For ease of description, an example is provided in which the duplexer 1040 that may separate the transmission frequency and the reception frequency is provided in the wireless communication device 1000.

The antenna 1050 may transmit an RF output signal RF_OUT, frequency-separated by the duplexer 1040, to the outside or provide an RF receive signal RF_R, received from the outside, to the duplexer 1040. For example, the antenna 1050 may include an array antenna, but example embodiments not limited thereto.

The antenna 1050 may be understood as having substantially the same configuration as the antenna device 100B illustrated in FIG. 7.

Accordingly, referring to FIGS. 7 and 10, the antenna 1050 (or the antenna device 100B) may include a feed line 210 and a plurality of antenna elements 221A to 22 nA formed on one surface of the substrate 120.

According to an example embodiment, the feed line 210 may be formed to extend in a predetermined direction (for example, a positive x-direction) on one surface of the substrate 120.

In addition, the plurality of antenna elements 221A to 22 nA may be alternately spaced apart each other and connected to each other at a predetermined interval in two directions (for example, a positive y-direction or a negative y-direction), substantially perpendicular to a direction in which the feed line 210 extends.

Each of the plurality of connection portions 211 to 21n of the feed line 210, to which the plurality of antenna elements 221A to 22 nA are connected, of the feed line 210 may have a first width W1.

A plurality of intermediate sections 231 to 23n of the feed line 210, excluding the plurality of connection points 211 to 21n, may each have a second width W2 smaller than the first width W1.

Accordingly, the feed line 210 may have a relatively high input impedance when viewed from the communication processor 1010 (or the communication circuit 110) compared to a case in which the entire feed line 210 has the first width W1. As the feed line 210 has a relatively high input impedance, the strength of the signal reflected from the other end of the feed line 210 may be reduced.

As a result, the antenna 1050 may reduce a phenomenon in which a radiation pattern of the RF signal changes due to destructive interference between a signal fed from a feed point P and a signal reflected from the other end of the feed line 210 at a specific frequency.

For example, the above-described configurations may enable the wireless communication device 1000 according to an example embodiment to transmit an RF signal having a consistent radiation pattern across a wide bandwidth through the antenna 1050.

Also, each of the plurality of antenna elements 221A to 22 nA according to an example embodiment may include an extension extending in a direction, substantially perpendicular to the first direction (for example, a positive y-direction or a negative y-direction) and a plurality of branches formed by branching from the extension.

For example, each of the plurality of antenna elements 221A to 22 nA may be formed in a Y shape extending from the feed line 210.

Also, the antenna 1050 according to an example embodiment may include a plurality of parasitic elements 241 to 24n disposed to be spaced apart from the feed line 210 at a location opposing each of the plurality of antenna elements 221A to 22 nA and the feed line 210.

The plurality of parasitic elements 241 to 24n may be electromagnetically coupled to the feed line 210 as the communication processor 1010 feeds power to the antenna 1050 through the feed line 210. Accordingly, a current may be induced in each of the plurality of parasitic elements 241 to 24n in a predetermined direction (for example, the positive y-direction).

Referring to the above-described configuration, a current flowing through the antenna 1050 according to an example embodiment may have a relatively high density with respect to the first direction (for example, the positive x-direction), compared to a case in which each of the plurality of antenna elements 221A to 22 nA does not include branches.

Also, the current flowing through the antenna 1050 according to an example embodiment may have a relatively high density with respect to the first direction (for example, the positive x-direction), compared to a case in which the plurality of parasitic elements 241 to 24n are not included.

As a result, the wireless communication device 1000 according to an example embodiment may have an improved antenna gain.

For reference, the communication processor 1010, the power modulator 1030, the RFIC 1020, the power amplifier PA, and the duplexer 1040 may be implemented as individual ICs, chips, or modules. Also, the communication processor 1010, the power modulator 1030, the RFIC 1020, the power amplifier PA, and the duplexer 1040 may be mounted together on a printed circuit board (PCB). However, example embodiments are not limited thereto. In some embodiments, at least a portion of the communication processor 1010, the power modulator 1030, the RFIC 1020, the power amplifier PA, and the duplexer 1040 may be implemented as a single communication chip.

Furthermore, the wireless communication device 1000 illustrated in FIG. 10 may be included in a wireless communication system using a cellular network such as 5G or LTE, and may also be included in a wireless local area network (WLAN) system or other arbitrary wireless communication systems. For reference, the configuration of the wireless communication device 1000 illustrated in FIG. 10 is only an example, and example embodiments are not limited thereto. The wireless communication device 1000 may be configured in various manners depending on a communication protocol or a communication scheme.

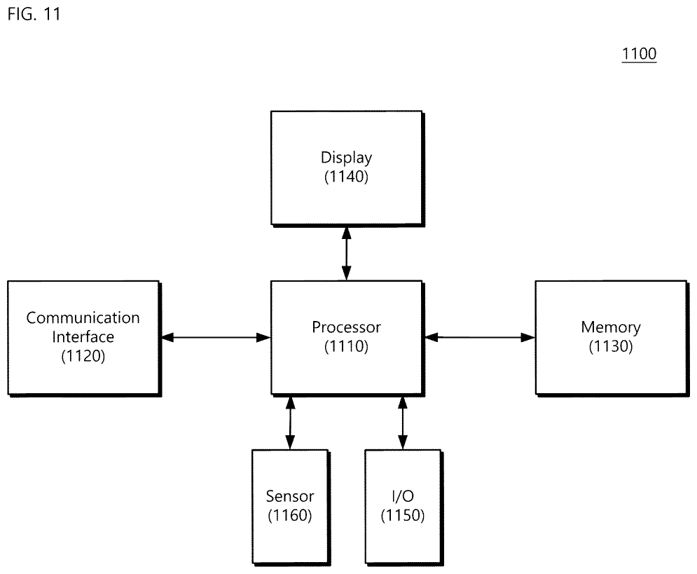

FIG. 11 is a block diagram illustrating an IoT device including an electronic device according to an example embodiment.

Referring to FIG. 11, Internet of Things (IoT) may refer to a network between things using wired communication and/or wireless communication. An IoT device may have accessible wired or wireless interfaces and may include device transmitting or receiving data by communicating with at least one other device through the wired or wireless interfaces. The accessible interfaces of the IoT device may include a wired local area network (LAN), a wireless local area network (WLAN) such as Wi-Fi, a wireless personal area network (WPAN) such as Bluetooth, wireless universal serial bus (USB), Zigbee, near field communication (NFC), radio-frequency identification (RFID), power line communication (PLC), or modem communication interfaces that may be connected to a mobile cellular network such as 3G, LTE, 4G, or 5G. The Bluetooth interface may support Bluetooth low energy (BLE).

For example, an IoT device 1100 may include a communication interface 1120 for communicating with external devices. The communication interface 1120 may be, for example, a wired LAN interface, a wireless LAN interface such as Bluetooth, Wi-Fi, Zigbee, a PLC, or a modem communication interface that may be connected to a mobile network such as 3G, LTE, 4G, or 5G.

The communication interface 1120 according to an example embodiment may include an antenna transmitting and receiving signals in a predetermined frequency band. For example, the communication interface 1120 illustrated in FIG. 11 may be understood to have substantially the same configuration as the feeder line 210 and the plurality of antenna elements 221 to 22 nA illustrated in FIG. 1.

In addition, the communication interface 1120 according to an example embodiment may include a transmitter and/or a receiver.

The IoT device 1100 may transmit and/or receive information from an access point or a gateway through the transmitter and/or receiver. In addition, the IoT device 1100 may communicate with a user device or other IoT devices to transmit and/or receive control information or data of the IoT device 1100.

The IoT device 1100 may include a processor 1110 performing computations. The processor 1110 of FIG. 11 may be understood to have substantially the same configuration as the communication circuit 110 of FIG. 1.

Referring to both FIG. 7 and FIG. 11, each of the plurality of connection portions 211 to 21n of the feeder line 210, to which the plurality of antenna elements 221A to 22 nA are connected, may have a first width W1.

Each of the plurality of intermediate portions 231 to 23n of the feeder line 210, excluding the plurality of connection portions 211 to 21n, may have a second width W2, smaller than the first width W1.

Accordingly, the feeder line 210 may have a relatively high input impedance when viewed from the communication processor 1010 (or the communication circuit 110), compared to a case in which the entire feeder line 210 has the first width W1. As the feeder line 210 has a relatively high input impedance, the strength of the signal reflected from the other end of the feeder line 210 may be reduced.

Accordingly, the communication interface 1120 may reduce a phenomenon in which the radiation pattern of the RF signal is changed at a specific frequency due to destructive interference between the signal fed from the feed point P and the signal reflected from the other end of the feeder line 210.

For example, the above-described configuration may enable the IoT device 1100 according to an example embodiment to transmit an RF signal having a consistent radiation pattern across a wide bandwidth via the communication interface 1120.

The IoT device 1100 may further include a power supply that incorporates a battery for internal power supply or receives power from the outside. In addition, the IoT device 1100 may include a display 1040 displaying an internal state or data. A user may control the IoT device 1100 through a user interface UI of the display 1140 of the IoT device 1100. The IoT device 1100 may transmit the internal state and/or data to the outside through the transmitter, and may receive control a command and/or data from the outside through the receiver.

The memory 1130 may store control a command code, control data, or user data for controlling the IoT device 1100. The memory 1130 may include at least one of a volatile memory and a nonvolatile memory. The nonvolatile memory may include at least one of various types of memory such as read-only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (ReRAM), or a ferroelectric RAM (FRAM). The volatile memory may include at least one of various types of memory such as a dynamic RAM (DRAM), a static RAM (SRAM), or a synchronous DRAM (SDRAM).

In addition, the IoT device 1100 may further include a storage device. The storage device may include at least one of nonvolatile media such as a hard disk drive (HDD), a solid state drive (SSD), an embedded multimedia card (eMMC), or a universal flash storage (USF). The storage device may store user information provided through an input/output unit (I/O) 1150 and sensing information collected through a sensor 1160.

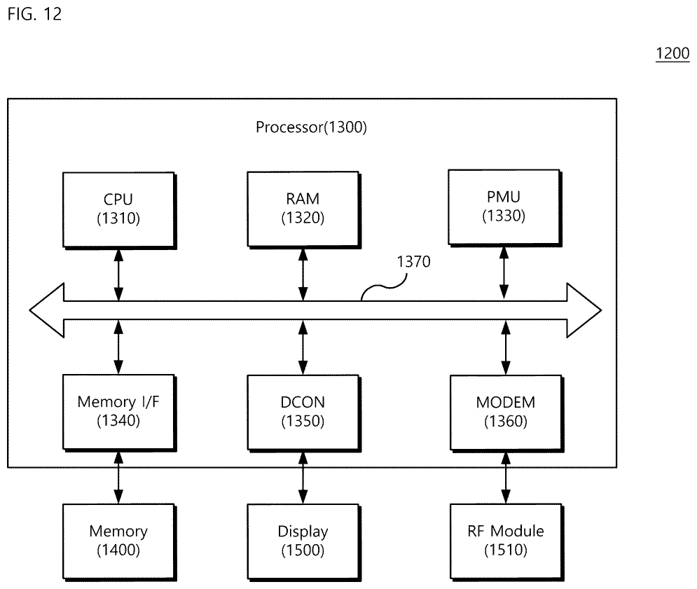

FIG. 12 is a block diagram illustrating a mobile terminal to which an electronic device according to an example embodiment is applied.

Referring to FIG. 12, a mobile device 1200 may include a processor 1300, a memory 1400, a display 1500, and a radio-frequency (RF) module 1510. The mobile device 1200 may further include various components such as a lens, a sensor, or an audio module.

The processor 1300 may be implemented as a system-on-chip (SoC), and may include a central processing unit (CPU) 1310, a RAM 1320, a power management unit (PMU) 1330, a memory interface (Memory I/F) 1340, a display controller (DCON) 1350, a modem 1360, and a bus 1370. The processor 1300 may also include various other intellectual properties (IPs). Functions of a modem chip are integrated into the processor 1300, so that the processor 1300 may be referred to as a modem application processor (ModAP), but example embodiments are not limited thereto.

The CPU 1310 may control the overall operation of the processor 1300 and the mobile terminal 1200. The CPU 1310 may control the operation of each component of the processor 1200. In addition, the CPU 1310 may be designed with a multicore architecture. The multicore architecture includes a single computing component with two or more independent cores.

The RAM 1320 may temporarily store programs, data, or instructions. For example, programs and/or data stored in memory 1400 may be temporarily stored in the RAM 1320 under the control of the CPU 1310 or based on a booting code. The RAM 1320 may be implemented as a DRAM or an SRAM.

The PMU 1330 may manage the power of each component of the processor 1300. Also, the PMU 1330 may determine an operating status of each component of the processor 1300 and control an operation thereof.

The memory interface 1340 may control the overall operation of memory 1400 and may control data exchange between each component of the processor 1300 and the memory 1400. The memory interface 1340 may write data in the memory 1400 or read data from the memory 1400 based on a request of the CPU 1310.

The display controller 1350 may transmit image data to be displayed on the display 1400 to the display 1500. The display 1500 may be implemented as a flat panel display such as a liquid crystal display (LCD) or an organic light-emitting diode (OLED), or as a flexible display.

The modem 1360 may modulate data to be transmitted to be appropriate to a wireless environment and recover received data. The modem 1360 may perform digital communication with the RF module 1510.

The modem 1360 illustrated in FIG. 12 may be may be referenced as having substantially the same configuration as the communication circuit 110 illustrated in FIG. 1.

The RF module 1510 may convert a high-frequency signal, received through the antenna, into a low-frequency signal and transmit the converted low-frequency signal to the modem 1360. In addition, the RF module 1510 may convert the low-frequency signal, received from the modem 1360, into a high-frequency signal and transmit the converted high-frequency signal to the outside of the mobile terminal 1200 through the antenna. The RF module 1510 may amplify or filter signals.

The RF module 1510 illustrated in FIG. 12 may be understood as including substantially the same configuration as the feed line 210 and the plurality of antenna elements 221 to 22n illustrated in FIG. 1.

As described above, the antenna device 100 according to an example embodiment may include a feed line 210 formed on one surface of a substrate 120 and a plurality of antenna elements 221 to 22n.

According to an example embodiment, the feed line 210 may be formed to extend in a predetermined direction (for example, a positive x-direction) on one surface of the substrate 120.

In addition, the plurality of antenna elements 221 to 22n may be alternately spaced apart each other and connected to each other at a predetermined interval in two directions (for example, a positive y-direction or a negative y-direction), substantially perpendicular to a direction in which the feed line 210 extends.

Each of the plurality of connection portions 211 to 21n of the feed line 210, to which the plurality of antenna elements 221 to 22n are connected, of the feed line 210 may have a first width W1.

A plurality of intermediate sections 231 to 23n of the feed line 210, excluding the plurality of connection points 211 to 21n, may each have a second width W2 smaller than the first width W1.

Accordingly, the feed line 210 may have a relatively large input impedance when viewed from the communication circuit 110, compared to a case in which the entire feed line 210 has the first width W1. As the feed line 210 has a relatively high input impedance, the strength of the signal reflected from the other end of the feed line 210 may be reduced.

As a result, the antenna device 100 may reduce a phenomenon in which a radiation pattern of the RF signal changes due to destructive interference between a signal fed from a feed point P and a signal reflected from the other end of the feed line 210 at a specific frequency.

The above-described configurations may enable the antenna device 100 according to an example embodiment to transmit an RF signal having a consistent radiation pattern across a wide bandwidth. For example, the antenna device 100 according to an example embodiment may significantly reduce a phenomenon in which an antenna gain decreases depending on a frequency.

Also, each of the plurality of antenna elements 221A to 22 nA according to an example embodiment may include an extension extending in a direction, substantially perpendicular to a first direction, (for example, a positive y-direction or a negative y-direction) and a plurality of branches formed by branching from the extension.

For example, each of the plurality of antenna elements 221A to 22 nA may be formed to have a Y-shape extending from the feed line 210.

The antenna 1050 according to an example embodiment may further include a plurality of parasitic elements 241 to 24n disposed to be spaced apart from the feed line 210 at a location opposing each of the plurality of antenna elements 221A to 22 nA and the feed line 210.

The plurality of parasitic elements 241 to 24n may be electromagnetically coupled to the feed line 210 as the communication processor 1010 feeds power to the antenna 1050 through the feed line 210. Accordingly, a current may be induced in each of the plurality of parasitic elements 241 to 24n in a predetermined direction (for example, the positive y-direction).

Referring to the above-described configurations, a current flowing due to the power feeding of the communication circuit 110 may have a relatively high density with respect to the first direction (for example, the positive x-direction), compared to a case in which each of the multiple antenna elements 221A to 22 nA does not include branches.

Also, the current flowing due to the power feeding of the communication circuit 110 according to an example embodiment may have a relatively high density with respect to the first direction (for example, the positive x-direction), compared to a case in which the plurality of parasitic elements 241 to 24n are not included.

As a result, the wireless communication device 1000 according to an example embodiment may have an improved antenna gain.

As set forth above, an antenna device according to example embodiment may transmit an RF signal having a consistent radiation pattern across a wide bandwidth.

While example embodiments have been shown and described above, it will be apparent to those skilled in the art that modifications and variations could be made without departing from the scope of the present inventive concept as defined by the appended claims.

What is claimed is:

1. An antenna device transmitting a radio-frequency (RF) signal, the antenna device comprising:
a feed line extending in a first direction on one surface of a substrate;
a first antenna element connected to the feed line in a second direction, substantially perpendicular to the first direction;
a second antenna element connected to the feed line, spaced apart from the first antenna element at a predetermined interval, and extending in a third direction, substantially perpendicular to the first direction and opposite to the second direction; and
a communication circuit configured to transmit the RF signal of a predetermined frequency band through the first antenna element and the second antenna element by feeding power to one end of the feed line,
wherein
the feed line comprises a first connection portion connected to the first antenna element, a second connection portion connected to the second antenna element, and a first intermediate portion between the first connection portion and the second connection portion, and
each of the first connection portion and the second connection portion has a first width, and the first intermediate portion has a second width smaller than the first width.

2. The antenna device of claim 1, wherein
the first antenna element comprises:
a first extension connected to the first connection portion and extending in the second direction, and
at least two first branches branching from the first extension.

3. The antenna device of claim 1, further comprising:
a first parasitic element disposed at a location opposing the first antenna element with respect to the first connection portion and spaced apart from the feed line; and
a second parasitic element disposed at a location opposing the second antenna element with respect to the second connection portion and spaced apart from the feed line.

4. The antenna device of claim 3, wherein
the first parasitic element comprises at least two first parasitic radiators, each extending in the third direction, and
the at least two first parasitic radiators are disposed substantially parallel to each other in the first direction.

5. The antenna device of claim 4, wherein
the at least two first parasitic radiators are electromagnetically coupled to the feed line as the communication circuit feeds power to the feed line.

6. The antenna device of claim 5, wherein
a current flows through each of the first antenna element, the second antenna element, the first parasitic element, and the second parasitic element in the second direction as the communication circuit feeds power to the feed line.

7. The antenna device of claim 1, further comprising:
a third antenna element spaced apart from the second antenna element by the predetermined interval and connected to the feed line in the second direction,
wherein
the feed line comprises a third connection portion connected to the third antenna element, and the third connection portion has the first width.

8. The antenna device of claim 1, wherein
the predetermined interval is substantially same as half a wavelength of the RF signal.

9. The antenna device of claim 1, wherein
the predetermined frequency band comprises a frequency band ranging from 76 GHz to 81 GHz.

10. The antenna device of claim 1, wherein
the feed line further comprises a termination extension extending from another end of the feed line by a predetermined extension length, and
the termination extension is connected to ground.

11. An antenna structure transmitting a radio-frequency (RF) signal, the antenna structure comprising:
a feed line extending in a first direction on one surface of a printed circuit board; and
a plurality of antenna elements alternately connected to the feed line at predetermined intervals in a second direction and a third direction, substantially perpendicular to the first direction,
wherein
the feed line comprises a plurality of connection portions, to which the plurality of antenna elements are respectively connected, and portions excluding the plurality of connection portions, and
each of the plurality of connection portions has a first width, and each of the portions excluding the plurality of connection portions has a second width smaller than the first width.

12. The antenna structure of claim 11, wherein
a first antenna element, among the plurality of antenna elements, connected to the feed line in the second direction comprises:
a first extension extending from the feed line in the second direction; and
at least two first branches branching from the first extension.

13. The antenna structure of claim 11, further comprising:
a plurality of parasitic elements spaced apart from the feed line at a location opposing each of the plurality of antenna elements with respect to the feed line,
wherein
the plurality of parasitic elements are electromagnetically coupled to the feed line.

14. The antenna structure of claim 13, wherein
the plurality of antenna elements and the plurality of parasitic elements radiate the RF signal of a predetermined frequency band in response to power fed through the feed line, and
the predetermined frequency band comprises a frequency band ranging from 76 GHz to 81 GHz.

15. The antenna structure of claim 14, wherein
the predetermined interval is substantially same as half a wavelength of the RF signal.

16. An antenna device comprising:
a substrate;
a feed line extending in a first direction on one surface of the substrate;
a plurality of antenna elements connected to the feed line at predetermined intervals on one surface of the substrate; and
a communication circuit configured to transmit a signal of a predetermined frequency band through the plurality of antenna elements by feeding power to one end of the feed line,
wherein
the feed line comprises a plurality of connection portions connected to the plurality of antenna elements, respectively, and portions excluding the plurality of connection portions, and
each of the plurality of connection portions has a first width, and each of the portions excluding the plurality of connection portions has a second width different from the first width.

17. The antenna device of claim 16, wherein
the plurality of antenna elements are alternately connected in a second direction, substantially perpendicular to the first direction, and a third direction, opposite to the second direction, and
the second width is smaller than the first width.

18. The antenna device of claim 17, wherein
a first antenna element, among the plurality of antenna elements, connected to the feed line in the second direction comprises:
a first extension extending from the feed line in the second direction; and
at least two first branches branching from the first extension.

19. The antenna device of claim 18, further comprising:
a first parasitic element disposed to be spaced apart from the feed line at a location opposing each of the plurality of antenna elements and the feed line,
wherein
the first parasitic element is electromagnetically coupled to the feed line as the communication circuit feeds power to the feed line.

20. The antenna device of claim 16, wherein
the feed line further comprises a termination extension extending from another end of the feed line by a predetermined extension length, and
the termination extension is connected to ground.
